(19) United States
(12) Patent Application Publication
(10) Pub. No.: US 2026/0019182 A1
(43) Pub. Date: Jan. 15, 2026

(54) METHOD FOR SMOOTHLY SWITCHING CLOCK INPUT SOURCES, ELECTRONIC DEVICE AND COMPUTER-READABLE STORAGE MEDIUM

(71) Applicant: Nanning FuLian FuGui Precision Industrial Co., Ltd., Nanning (CN)

(72) Inventors: Shi-Li Wang, Shenzhen (CN); Hong-Bo Huang, Shenzhen (CN)

(21) Appl. No.: 18/789,831

(22) Filed: Jul. 31, 2024

(30) Foreign Application Priority Data
Jul. 10, 2024 (CN) 202410925690.5

(51) Int. Cl. H04J 3/06

(52) U.S. Cl. CPC H04J 3/0667; H04J 3/0641

(57) ABSTRACT

A method for smoothly switching clock input sources is disclosed. A precision time protocol (PTP) input source is selected according to an initial configuration for time synchronization. It is determined whether pulse signals of the PTP input source within a time duration T are detected as a normal state. If the pulse signals of the PTP input source within the time duration T are detected as the normal state, the PTP input source is locked. An oven-controlled crystal oscillator (OCXO) input source is adjusted, according to a PTP timestamp for calibration, to enable the pulse signals of the OCXO input source to follow the pulse signals of the PTP input source.

### FIELD

The disclosure relates to time synchronization, and more particularly to a method for smoothly switching clock input sources, electronic device and computer-readable storage medium.

### BACKGROUND

FIG. 1 is a schematic diagram of a 5th generation mobile network (5G) radio unit (RU) time synchronization system. The 5G RU time synchronization system 100 comprises a baseband unit (BBU) 110 and a 5G RU 130. The BBU 110 comprises a global positioning system (GPS) antenna 111, an oven-controlled crystal oscillator (OCXO) module 112 and a precision time protocol (PTP) module 113. The 5G RU 130 comprises a BBU 150. The BBU 150 further comprises a GPS antenna 151, an OCXO module 152 and a PTP module 153 and a time synchronization module 154. The PPT 113 and PPT 153 are connected via a communication media 120, for example, an optical fiber or an RJ45 cable.

In order to ensure the stability, security and accuracy of synchronization performance of the 5G RU, a 5G RU equipment generally supports multiple clock synchronization sources, also called clock input sources, such as GPS, PTP, synchronous ethernet (SyncE) and OCXO. The GPS input source is chosen for relatively open outdoor areas, the PTP input source is used for indoor and other scenes where it is difficult to deploy GPS antennas, and the OCXO input source is chosen when there is no GPS input source or PTP input source.

However, if the GPS satellite reception signal is interrupted or the quality is degraded, it is very important for the 5G RU equipment to automatically switch between the GPS input source and the PTP input source, and to ensure that the time synchronization jitter is small during a switching process of synchronization sources.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a schematic diagram of a 5G RU time synchronization system;

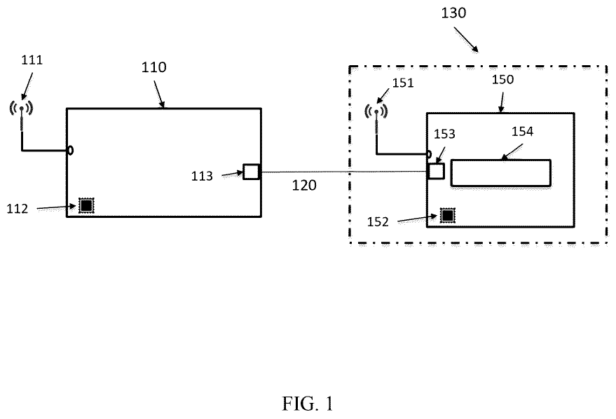

FIG. 2 is a block diagram of an embodiment of functional blocks of a device for smoothly switching clock input sources of the present disclosure;

FIG. 3 is a flowchart of an embodiment of a method for smoothly switching clock input sources of the present disclosure; and

FIG. 4 is a block diagram of an embodiment of the hardware architecture of an electronic device using the method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

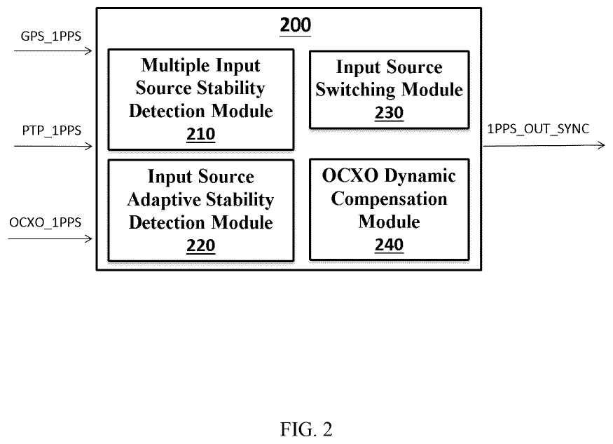

FIG. 2 is a block diagram of an embodiment of functional blocks of a device for smoothly switching clock input sources of the present disclosure. A device for smoothly switching clock input sources 200, for example, a 5G RU equipment, comprises a multiple input source stability detection module 210, an input source adaptive stability detection module 220, an input source switching module 230 and an oven-controlled crystal oscillator (OCXO) dynamic compensation module 240.

The multiple input source stability detection module 210 is suitable for the situation that main clock input sources of a system for smoothly switching clock input sources exist. Each clock input source is compared in pairs and the rising edge time error (TE) of a pulse per second (1PPS) is calculated to determine the stability of the clock input sources. The main clock input sources of the system are the GPS and the PTP, and the backup clock input source is the OCXO.

The multiple input source stability detection module 210 detects 1PPS input signal indicators of the main clock input sources at all times and calculates the time error ΔTE between the 1PPS rising edge time of the current clock input source and the 1PPS rising edge time of other clock input sources within time T. The deviation range of ΔTE is ±100 ns. Regarding the currently selected PTP input source as an example, the time error between the 1PPS rising edge time of the PTP input source and the 1PPS rising edge time of the OCOX input source and the 1PPS rising edge time of the GPS input source and the 1PPS rising edge time of the OCOX input source are calculated, which are represented as follows:
the 1PPS rising edge time of the PTP input source and the 1PPS rising edge time of the OCOX input source: ΔTE_{PO}=TE_{PTP}−TE_{OCOX}; and
the 1PPS rising edge time of the GPS input source and the 1PPS rising edge time of the OCOX input source: ΔTE_{PG}=TE_{PTP}−TE_{GPS}.

If both the ΔTE_{PO} and the ΔTE_{PG} are within the error range, it means that the PTP input source is normal.

If at least one of the ΔTE_{PO} and the ΔTE_{PG} is not within the error range, the input source adaptive stability detection module 220 determines whether the clock input source is normal.

The input source adaptive stability detection module 220 is suitable for situations where one of the main clock input sources is lost or restored, detects the input signal indicators of 1PPS signals at all times, and calculates the mean u and variance σ of N groups of 1PPS rising edge time errors within time T. If the mean u and the time error of each group of 1PPS signals are both within a preset range, for example, ±100 ns, and the variance σ is also within another preset range, for example, 0≤σ≤σₘₐₓ, the PTP input source is stable, and, otherwise, the PTP input source is detected as abnormal. σₘₐₓ is obtained by computer dynamic programming or the exhaustive algorithm. It is noted that the calculation method of the mean u and variance σ of the 1PPS rising edge time error is common knowledge among those skilled in the art and will not be described again in this article.

When an abnormality in one of the 1PPS signals of the main clock input source is detected, the input source switching module 230 automatically switches from the main clock input source to another main clock input source. If the 1PPS signals of the two main clock input sources are abnormal, the input source switching module 230 automatically switches from the main clock input source to the OCXO input source, and the OCXO maintains time synchronization.

When at least one 1PPS signal of the main clock input source is normal, the OCXO dynamic compensation module 240 dynamically adjust the OCXO input source by time stamps of the main clock, so that the 1PPS signals output by the OCXO input source follows the 1PPS signals input by the main clock input source. It should be noted that the OCXO dynamic compensation method is common knowledge among those skilled in the art and will not be described again in this article.

The main clock input source of the device for smoothly switching clock input sources 200 is in the same time reference system. The multiple input source stability detection module 210 and the input source adaptive stability detection module 220 detect, at all times, whether the 1PPS signals of the main clock input sources are normal. If the 1PPS signals of at least one of the main clock input sources is normal, the input source switching module 230 locks the input source detected as normal, and dynamically compensates the OCXO according to the timestamps of the main clock. Otherwise, the input source switching module 230 locks the OCXO and the input source adaptive stability detection module 220 continues to detect whether the main clock input source is restored. If the 1PPS signals of at least one main clock input source is restored and stable within a period of time, the input source switching module 230 locks the main clock input source, while the timestamps of the main clock is used to continue to dynamically compensate the OCXO.

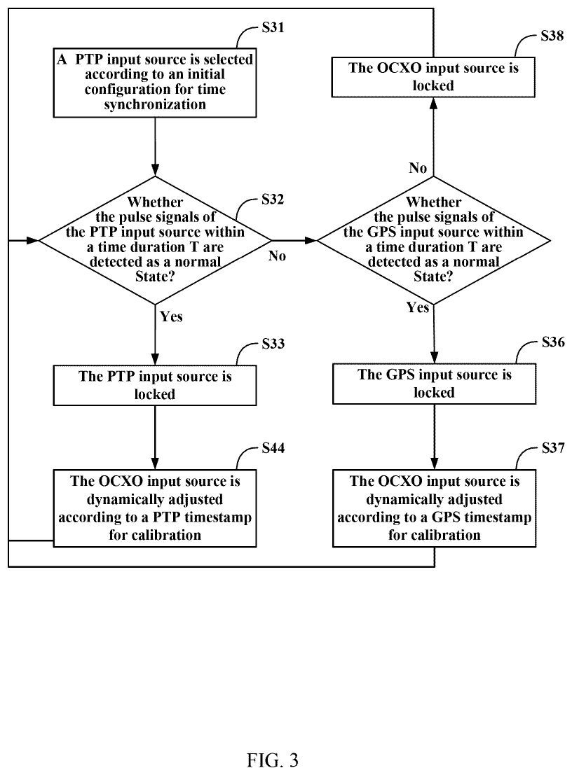

FIG. 3 is a flowchart of an embodiment of a method for smoothly switching clock input sources of the present disclosure. According to different needs, the order of the steps in the flowchart can be changed, and some steps can be omitted.

In step S31, when a system for smoothly switching clock input sources is activated, the input source switching module 230 selects a PTP input source according to an initial configuration for time synchronization.

In step S32, the multiple input source stability detection module 210 determines whether pulse signals, for example, the pulse per second (1PPS) signals, of the PTP input source within a time duration T are detected as a normal state.

In step S33, if the pulse signals of the PTP input source within the time duration T are detected as the normal state, the input source switching module 230 locks the PTP input source.

In step S34, the OCXO dynamic compensation module 240 adjusts an OCXO input source, according to a PTP timestamp for calibration, to enable the pulse signals of the OCXO input source to follow the pulse signals of the PTP input source.

In step S35, if the pulse signals of the PTP input source within the time duration T are detected as an abnormal state, the input source adaptive stability detection module 220 determines whether pulse signals of a global positioning system (GPS) input source within the T period are detected as the normal state.

In step S36, if the pulse signals of the GPS input source within the T period are detected as the normal state, the input source switching module 230 locks the GPS input source.

In step S37, the OCXO dynamic compensation module 240 dynamically adjusts the OCXO input source according to a GPS time stamp of the GPS input source for calibration to enable the pulse signals of the OCXO input source to follow the pulse signals of the GPS input source.

In step S38, if the pulse signals of the GPS input source within the T period are detected as the abnormal state, the input source switching module 230 locks the OCXO input source and continuously detects whether the pulse signals of the PTP input source and the pulse signals of the GPS input source have returned to the normal state.

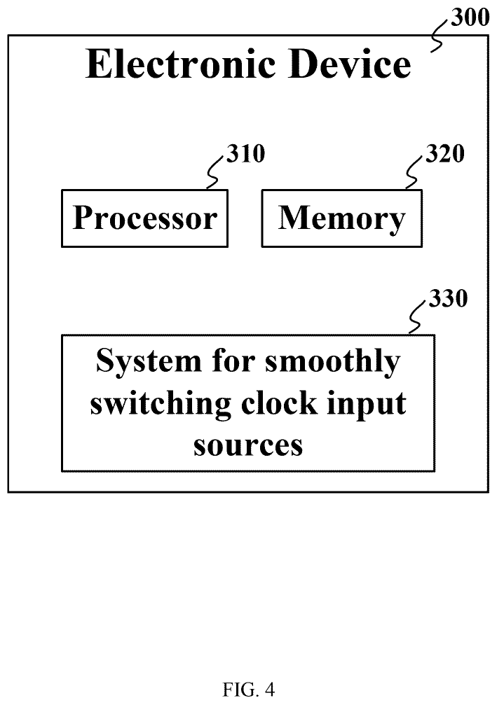

FIG. 4 is a block diagram of an embodiment of the hardware architecture of an electronic device using the method for smoothly switching clock input sources of the present disclosure. The electronic device 300 may be, but is not limited to, connected to a processor 310, a memory 320, and a system for smoothly switching clock input sources 330 via system buses. The electronic device 300 shown in FIG. 4 may include more or fewer components than those illustrated or may combine certain components.

The memory 320 stores a computer program, such as the system for smoothly switching clock input sources 330, which is executable by the processor 310. When the processor 310 executes the system for smoothly switching clock input sources 330, the blocks in one embodiment of the booting mode configuration method applied in the electronic device 300 are implemented, such as blocks S31 to S38 shown in FIG. 3.

It will be understood by those skilled in the art that FIG. 4 is merely an example of the electronic device 300 and does not constitute a limitation to the electronic device 300. The electronic device 300 may include more or fewer components than those illustrated, or may combine certain components. The electronic device 300 may also include input and output devices, network access devices, buses, and the like.

The processor 310 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 310 may be a microprocessor or other processor known in the art.

The memory 320 can be used to store the system for smoothly switching clock input sources 330 and/or modules/units by running or executing computer programs and/or modules/units stored in the memory 320. The memory 320 may include a storage program area and a storage data area. In addition, the memory 320 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The system for smoothly switching clock input sources 330 can be partitioned into one or more modules/units that are stored in the memory 320 and executed by the processor 310. The one or more modules/units may be a series of computer program instructions capable of performing particular functions of the system for smoothly switching clock input sources 330.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method for smoothly switching clock input sources executable by an electronic device, the method comprising:
selecting a precision time protocol (PTP) input source according to an initial configuration for time synchronization;
determining whether pulse signals of the PTP input source within a time duration T are detected as a normal state;
if the pulse signals of the PTP input source within the time duration T are detected as the normal state, locking the PTP input source; and adjusting an oven-controlled crystal oscillator (OCXO) input source, according to a PTP timestamp for calibration, to enable the pulse signals of the OCXO input source to follow the pulse signals of the PTP input source.

2. The method of claim 1, further comprising:
if the pulse signals of the PTP input source within the time duration T are detected as an abnormal state, determining whether pulse signals of a global positioning system (GPS) input source within the T period are detected as the normal state;
if the pulse signals of the GPS input source within the T period are detected as the normal state, locking the GPS input source; and
dynamically adjusting the OCXO input source according to a GPS time stamp of the GPS input source for calibration to enable the pulse signals of the OCXO input source to follow the pulse signals of the GPS input source.

3. The method of claim 2, further comprising:
if the pulse signals of the GPS input source within the T period are detected as the abnormal state, locking the OCXO input source and continuously detecting whether the pulse signals of the PTP input source and the pulse signals of the GPS input source have returned to the normal state.

4. An electronic device, which includes a memory, a processor, and a serial number of programs, of a method for smoothly switching clock input sources, stored in the memory and operable on the processor, wherein the serial number of programs is executed by the processor to implement following instructions:
selecting a PTP input source according to an initial configuration for time synchronization;
determining whether pulse signals of the PTP input source within a time duration T are detected as a normal state;
if the pulse signals of the PTP input source within the time duration T are detected as the normal state, locking the PTP input source; and
adjusting an OCXO input source, according to a PTP timestamp for calibration, to enable the pulse signals of the OCXO input source to follow the pulse signals of the PTP input source.

5. The device of claim 4, wherein the serial number of programs is executed by the processor to implement following instructions:
if the pulse signals of the PTP input source within the time duration T are detected as an abnormal state, determining whether pulse signals of a global positioning system (GPS) input source within the T period are detected as the normal state;
if the pulse signals of the GPS input source within the T period are detected as the normal state, locking the GPS input source; and
dynamically adjusting the OCXO input source according to a GPS time stamp of the GPS input source for calibration to enable the pulse signals of the OCXO input source to follow the pulse signals of the GPS input source.

6. The device of claim 5, wherein the serial number of programs is executed by the processor to implement following instructions:
if the pulse signals of the GPS input source within the T period are detected as the abnormal state, locking the OCXO input source and continuously detecting whether the pulse signals of the PTP input source and the pulse signals of the GPS input source have returned to the normal state

7. A non-transitory computer-readable storage medium storing game program which causes a computer to execute:
a process of selecting a PTP input source according to an initial configuration for time synchronization;
a process of determining whether pulse signals of the PTP input source within a time duration T are detected as a normal state;
a process of, if the pulse signals of the PTP input source within the time duration T are detected as the normal state, locking the PTP input source; and
a process of adjusting an OCXO input source, according to a PTP timestamp for calibration, to enable the pulse signals of the OCXO input source to follow the pulse signals of the PTP input source.

8. The non-transitory computer-readable storage medium of claim 7 storing game program which causes a computer to execute:
a process of, if the pulse signals of the PTP input source within the time duration T are detected as an abnormal state, determining whether pulse signals of a global positioning system (GPS) input source within the T period are detected as the normal state;
a process of, if the pulse signals of the GPS input source within the T period are detected as the normal state, locking the GPS input source; and
a process of, dynamically adjusting the OCXO input source according to a GPS time stamp of the GPS input source for calibration to enable the pulse signals of the OCXO input source to follow the pulse signals of the GPS input source.

9. The non-transitory computer-readable storage medium of claim 8 storing game program which causes a computer to execute:
a process of, if the pulse signals of the GPS input source within the T period are detected as the abnormal state, locking the OCXO input source and continuously detecting whether the pulse signals of the PTP input source and the pulse signals of the GPS input source have returned to the normal state
